(19) United States
(12) Patent Application Publication
(10) Pub. No.: US 2025/0156856 A1
(43) Pub. Date: May 15, 2025

(54) SECURE TRANSACTION UNIT, ELECTRONIC TOKEN TRANSACTION SYSTEM, AND METHOD IN A SECURE TRANSACTION UNIT

(71) Applicant: Giesecke+Devrient advance52 GmbH, Munich (DE)

(72) Inventor: Lars HUPEL, Munich (DE)

(21) Appl. No.: 18/941,413

(22) Filed: Nov. 8, 2024

(30) Foreign Application Priority Data
Nov. 9, 2023 (EP) 23208697.5

(51) Int. Cl. G06Q 20/38; G06Q 20/40

(52) U.S. Cl. CPC G06Q 20/382; G06Q 20/389; G06Q 20/401

(57) ABSTRACT

The invention relates to a secure transaction unit for use in an electronic token transaction system, the secure transaction unit at least comprising: a secure element; and a special secure element for temporary offline storing of history data related to tokens being transacted within offline token transactions; wherein the secure element receives at least one token from another secure element when performing an offline token transaction between the secure element and the other secure element; wherein the special secure element receives directly or indirectly history data related to the received at least one token from the other secure element for temporary offline storing of history data related to the token transaction performed by the secure element; and provides the temporarily stored history data to a token register.

### BACKGROUND

The invention relates to a secure transaction unit for use in an electronic token transaction system. The invention also refers to an electronic token transaction system. The invention also relates to a method in a secure transaction unit of an electronic token transaction system.

Tokens—also referred to as digital assets, electronic coins, and/or coin data sets—may represent any digital asset, in particular a digital currency, preferably a central bank digital currency (CBDC). These tokens are issued and deleted by an issuing unit of a token transaction system, such as an issuing authority, or a central bank unit or a commercial bank unit.

Payment transactions and associated payment transaction data must be safe and secure and so, means for protecting confidentiality, integrity, and availability of exchanged payment transaction data must be implemented.

In conventional electronic payment systems respectively electronic token transaction systems, tokens can directly be shared between individual payment system participants, i.e. secure elements, such as chip cards, SIM modules, etc. The token transferred within such an electronic payment system is valid upon direct receipt from another participant without a need of approval or verification via an online connection. Tokens can be modified by each individual participant, e.g., ownership of tokens can be switched from one participant to another participant (SWITCH modification), tokens can be split into plural tokens to reduce a monetary value (SPLIT modification) and/or tokens can be merged to become one token having a higher monetary value (MERGE modification).

Each modification to a token can be—but does not have to be—registered in a verification register, hereinafter also referred to as token register or verifier. This token register stores a token reference of the token but does not store the token itself to ensure anonymity in the payment system. The token register is an entity of the electronic payment transaction system but is remote to participants. Thus, the token register may be reached via online connection, e.g., an internet communication and/or well-established protocols, such as TCP, IP, UDP, HTTPS, FTP and/or another suitable protocol.

One design aspect of such payment systems is that a token must be verifiable by each participant in the system at any time. This can be done online via the token register upon sending a registration request from the participant (i.e. via a secure element and/or a secure transaction unit).

If an online connection is not available or inconvenient or should not be used, it is still possible to use a modified token as a valid token within the electronic token transaction system. This is possible, because a token may comprise a token history, hereinafter also referred to as history data, attached to the token that protocols one or more previous modifications. So, it is necessary to generate and attach a token history entry for each modification made with the token in case a registration of that modification at the token register, e.g., via an online connection to the token register, is unavailable or inconvenient or should not be used at the time of the modification. A token history may have one or more token history entries each being referred to one modification of the token. A token history entry can also be referred to as a “proof” and/or history data.

As a drawback of known systems, the larger the token history is—meaning the more token history entries (modifications related to the token) are attached to or stored with the token itself—the more storage space and computing performance and network performance is necessary for storing, managing and/or transmitting/receiving an individual token. Furthermore, since more data needs to be processed and transmitted between individual participants, the time duration for performing a token transfer heavily increases and may lead to unwanted time-out scenarios, e.g. in a wireless local payment transaction between secure elements (e.g. via NFC, Bluetooth, etc.) and/or user acceptance is lowered.

Since a secure element is a computing device with limited resources such as storage capacity and processing power, there is need to reduce the data size of a token without reducing security, flexibility, or anonymity of the electronic token respectively payment transaction system, especially in scenarios in which an online connectivity to a token register cannot or should not be established. Further, there is a need to reduce the time duration of the token transfer in order to increase the number of token transactions.

The above-identified objectives are solved with the features of the independent patent claims. Further advantageous embodiments are described in the dependent patent claims.

### SUMMARY

In an aspect of the present invention, there is provided a secure transaction unit for use in an electronic token transaction system. The secure transaction unit at least comprises a secure element and a special secure element for temporary offline storing of history data related to tokens being transacted within offline token transactions. The secure element may comprise a secure element computing unit and a token storage for a token of the electronic token transaction system, the secure element computing unit configured for exchanging or receiving at least one token from another secure element when performing an offline token transaction between the secure element and the other secure element. The secure element may be further configured to modify tokens (switch, split, merge).

The special secure element may comprise a special secure element computing unit and a secure storage unit, the special secure element computing unit configured for receiving directly or indirectly history data related to the received at least one token from the other secure element for temporary offline storing of the history data related to a token transaction performed by the secure element and further configured for providing the temporarily stored history data to a token register.

In other words, this aspect includes a secure transaction unit for use in an electronic token transaction system comprising a secure element, wherein the secure element is configured for receiving at least one token from another secure element when performing an offline token transaction between the secure element and the other secure element where a token is transferred without registering the transferred token but storing history data for later registration. The secure transaction unit comprises history data related to the received at least one token, wherein the history data have to be sent to a token register of the transaction system. The secure transaction unit comprises a special secure element, wherein the special secure element is configured for receiving directly or indirectly the history data from the other secure element, for temporarily storing the history data and for providing the history data to the token register.

The secure transaction unit represents any unit configured for use in an electronic token transaction system and configured for providing respectively enabling a token transaction between two different secure elements, respectively payment participants. For instance, the secure transaction unit may be a smart phone, a tablet computer, a computer, a server or a merchant terminal, in particular a point of sale, POS, system but is not limited thereto. The secure transaction unit may comprise a secure element, e.g. in case of the merchant terminal this may be a merchant (smart) card and/or computing unit, and a special secure element, e.g. another smart card, computing unit and/or a secure storage unit. Both, the secure element and the special secure element are arranged fully or at least partially within the secure transaction unit. In other words, both the secure element and the special secure element are not connected to the secure transaction unit in a remote manner, e.g. via a communication network etc. For instance, in case the secure transaction unit is a merchant terminal having a housing, both the secure element and the special secure element are fully or at least partially inserted respectively arranged within the merchant terminal, in particular within a housing of the merchant terminal.

The secure element, also referred to as secure wallet, represents any secure token management unit; token wallet; and/or wallet that may be used to locally manage tokens in the secure element itself and/or to modify the tokens and to register the tokens in the electronic token transaction system. In other words, the secure element represents a participant for the token transaction. The secure element is un-hosted, so it is not hosted within another entity of the payment system, e.g. a service provider unit or the like. The secure element may comprise at least one of a means configured for providing a token transaction request to another secure element, a means configured for receiving at least one token from another secure element when performing an offline token transaction between the secure element and the other secure element, a means configured for receiving the history data from the other secure element, a means configured for providing the history data to the special secure element, a means configured for providing a registration request to the special secure element for providing the history data to the token register, and a means configured for receiving a registration response from the token register.

A special secure element represents another secure element (different from the secure element above) configured for only storing, in particular temporary storing, the history data related to a token. The special secure element is a secure element that may be configured for only storing a plurality of history data from a plurality of different secure elements. The special secure element may be un-hosted. For instance, the special secure element may have a higher level of security and/or a higher level of performance compared with a (normal, not-special) secure element. Exemplary, the special secure element comprises a higher amount of memory (storage) space and/or more computing power if compared with a (normal, not-special) secure element. The special secure element temporarily stores the history data, wherein temporarily storing herein means that the history data are stored at the special secure element for instance as long as the secure transaction unit is offline, i.e. a communication connection to the token register is not available or is not sufficient to enable a registration of the token at the token register or the secure transaction unit is in a mode (online or offline) in which sending registration requests to the token register is not enabled or wanted or not allowed. When a communication connection between the secure element and the token register is available or is sufficient to enable a registration of the token at the token register, i.e. the secure transaction unit is online or in a mode in which sending registration requests to the token register is enabled or is wanted or is allowed, the history data can be provided to the token register for the registration. In other words, a temporary storing may only be executed when a communication connection between the secure element and the token register is insufficient or is disabled or is unwanted or is unallowed to enable a registration of the token at the token register.

In a preferred embodiment, the history data of the token of the offline transaction can be provided from the special secure element to the token register without the secure element. Thus, there is a direct (logic) communication between the special secure element and the token register without interference of the secure element of the transaction unit. There may be a direct (logic) communication between the special secure element and the token register via the transaction unit without interference of the secure element of the transaction unit.

In a preferred embodiment, the secure element may in particular be able to perform a further offline transaction with the (unregistered) token in parallel. This means that the secure element can validly perform further offline transactions with modified tokens that are not registered in the token register, wherein the tokens of this further offline transaction are without the history data.

With this aspect, it is assured that the data size of a token can be significantly reduced, e.g. when performing such further offline transactions, such that the computing power of the secure element can be relieved such that a time duration of a transmission, receipt and/or transmission of the token can be significantly decreased and the number of possible token transactions can be significantly increased.

In a preferred embodiment of the secure transaction unit, the secure transaction unit is a merchant terminal. The merchant terminal represents any payment terminal/point of sale, POS, terminal configured for providing an electronic token transaction.

In a preferred embodiment of the secure transaction unit, the secure token transaction unit or the secure element further comprises a means configured for providing a token transaction request to the other secure element. The token transaction request represents any request, any query, or any question for initiating a token transaction between the other secure element and the secure element. Additionally, the token transaction request may initiate a providing of the history data from the other secure element to the special secure element. The token transaction request may be generated by the secure element. The token transaction request is provided from the secure element to the other secure element. The token transaction request may include a string and/or an integer but is not limited thereto. For instance, the token transaction request may include an instruction like “pay” together with a value, the date, and the purpose but is not limited thereto.

These means configured for providing the token transaction request to the other secure element may be a token transaction interface of the secure transaction unit, e.g. a contact-based or contactless (local) communication interface for token transactions (token transfer) between the other secure element and the secure element. The communication for exchanging tokens can take place wirelessly or by wire, or for example also on an optical path, preferably via QR code or barcode, and can be designed as a secure channel. The exchange of tokens is, for example, additionally protected by cryptographic keys, for example a session key negotiated for a token exchange or on the basis of a subscriber-unit-individual key pair.

In a preferred embodiment of the secure transaction unit, the secure element further comprises a means configured for receiving the history data from the other secure element, a means configured for providing the history data to the special secure element, and/or a means configured for providing a registration request to the special secure element for providing the history data to the token register.

The registration request represents any request, any query, or any question for providing the history data from the special secure element to the token register for the registration of the token. The registration request is provided respectively transmitted from the secure element to the special secure element. The registration request may be provided respectively generated by the secure element. The registration request, also referred to as replacement request, may be in a specific format to transfer the history data of the token to the token register. The registration request may include a string and/or an integer but is not limited thereto.

By including means configured for receiving the history data from the other secure element, a means configured for providing the history data to the special secure element, and/or a means configured for providing a registration request to the special secure element, an indirect providing of the history data related to the received at least one token from the other secure element to the special secure element can be provided.

In a preferred embodiment of the secure transaction unit, the special secure element further comprises a means configured for receiving the registration request from the transaction unit and/or the secure element.

By receiving the registration request, the special secure element initiates a transmission respectively providing of the history data to the token register. Therefore, the registration, in particular the interval of registration, of the token can be controlled.

In a preferred embodiment of the secure transaction unit, the secure element further comprises a means configured for receiving a registration response from the token register.

The registration response represents any data respectively information indicating the failure or the success of the registration respectively verification of a token. The registration response may be provided respectively generated by the token register and may be provided respectively transmitted from the token register to the secure element. For instance, the registration response may be provided as a string or integer but is not limited thereto. Exemplary, the registration response may include the term “YES” or “NO” indicating the success or the failure of the registration. For instance, the registration response may include a status-code (200 for OK, 400 for NOT OK, or 500 for SERVER ERROR) together with a hash and a signature of the request such that a secure element can validate the registration response.

By providing a registration response from the token register to the secure element, the success or failure of the registration of a token can be analyzed respectively detected such that the validity of the token can be verified, analyzed and/or indicated.

In another aspect of the invention there is provided an electronic token transaction system. The electronic token transaction system comprises a plurality of other secure elements, at least one secure transaction unit as described above, and at least one token register.

In another aspect of the invention there is provided a method in a secure transaction unit of an electronic token transaction system. The method comprises the following steps: receiving by a secure element at least one token from another secure element when performing an offline token transaction between the secure element and the other secure element, receiving by a special secure element history data directly or indirectly from the other secure element for temporary offline storing of the history data related to a token transaction performed by the secure element, providing the history data for a registration from the special secure element to a token register of the electronic token transaction system.

In a preferred embodiment of the method, when the received history data are indirectly provided to the special secure element, the method further comprises the steps of: receiving history data by the secure element from the other secure element; and providing the received history data from the secure element to the special secure element.

In a preferred embodiment of the method, the method further comprises the step of: providing a registration request from the secure element to the special secure element; and/or receiving by the secure element a registration response from the token register; and/or providing a token transaction request from a secure element to another secure element.

In the following, the invention or further embodiments and advantages of the invention are explained in more detail based on drawings, wherein the drawings describe only embodiments of the invention. Identical components in the drawings are given the same reference signs. Elements drawn with dashed lines are considered as optional elements.

### BRIEF DESCRIPTION OF THE DRAWINGS

The drawings are not to be regarded as true to scale, and individual elements of the drawings may be shown in exaggeratedly large or exaggeratedly simplified form.

FIG. 1 shows an exemplary embodiment of a secure transaction unit.

FIG. 2 shows an exemplary embodiment of an electronic token transaction system.

FIG. 3 shows an exemplary embodiment of a method in a secure transaction unit of an electronic token transaction system in which the history data are directly provided to the special secure element.

FIG. 4 shows an exemplary embodiment of a method in a secure transaction unit of an electronic token transaction system in which the history data are indirectly provided to the special secure element.

### DETAILED DESCRIPTION OF THE INVENTION

According to the described embodiments, a token may comprise a data set in an electronic token transaction system that can be directly exchanged between secure transaction units or secure elements, such as described in U.S. patent application Ser. No. 18/681,041, published Aug. 15, 2024 as US 2024/0275599 A1, and International Patent Application PCT/DE2023/100487, filed Jun. 28, 2023 and published Feb. 8, 2024 as WO 2024/027869 A1, which applications are each incorporated herein by reference in their entirety. With knowledge of the token, the receiving secure transaction unit is in possession of the token value that the token represents. With an exchange, the token accordingly automatically changes owner. A token—a data set that is transmittable independently of a transaction topology, such as blockchain topologies “Bitcoin”, “Ethereum”, or “Neo”—can be transmitted directly between secure transaction units e.g., without intermediary units. In colloquial terms, such a token may also be referred to as a “digital coin” or “electronic coin” and represents cash in electronic form.

Each token in an electronic token transaction system may comprise at least two token elements. A first token element of each token may comprise a token value, for example an asset value, an asset, a commodity, and/or a monetary value. A second token element of each token may be a private part of a token-individual key pair. This private part is a secret in the electronic token transaction system and is not published and may not be used multiple times. The creation of the private part must not be predictable. This private part can be a random number.

The token may be formed from the token value (first token element) and the private part. This formation is preferably the chaining (concatenation) of these two token elements. Any other type of chaining of these two token elements is not excluded according to the invention and includes, for example, back-end attachment, introduction into a TLV data structure and/or logical chaining.

The token differs from a data set for classic data exchange or data transfer, as classic data exchange is based on a question-and-answer principle or on intercommunication between the partners in the data exchange, for example. A token, on the other hand, is singular and unique in the transaction system. The token is part of a security concept that comprises signatures or cryptographic encryption, for example. A token contains all the data elements required by a receiving secure transaction unit for verification, authentication, and forwarding the token to another secure element.

A secure transaction unit cannot create or delete tokens, it can only modify tokens (switch, split, merge). The secure transaction unit may be configured to provide modification information as a registration request to a token register.

A secure transaction unit in possession of a token or having unrestricted access to the token with its token elements can exchange this token with another secure transaction unit. The possession of the token with its at least two token elements (token value and private part of the token-individual key pair) is thus equivalent to the possession of the value representing the token.

A token reference may be assigned to each token in the transaction system. This assignment is unique, i.e. one token reference is assigned to precisely one token, and each token reference is assigned precisely one token. The token reference may be a public data set which is stored, such that it can be reviewed, in a memory unit of the token register of the electronic token transaction system for each secure transaction unit.

Both the token and the token reference are unique. Due to the unique assignment, there is a 1-to-1 relationship between the token and the token reference.

Each token reference in the transaction system is a data set comprising at least two token reference elements.

A first token reference element of each token reference may be the token value of the token uniquely assigned to the token reference. The token value of the token is thus identical to the token value of the assigned token reference. For example, the token value of the token reference is a copy of the token value of the assigned token.

A second token element of each token reference of the transaction system is a public part of the token-individual key pair. Together with the private part of the token, this public part of the token reference forms the token-individual key pair. The public part is obtained by applying a cryptographic function to the private part.

This cryptographic function is a one-way function. This cryptographic function is accordingly a mathematical function which can be calculated “easily” in terms of complexity theory, but is “difficult” up to virtually impossible to reverse. In this case, a one-way function also denotes a function for which, hitherto, a reversal that is practically executable within a reasonable time and with reasonable effort has not been known. Preferably, a one-way function is used which operates on a group in which the discrete logarithm problem is difficult to resolve, such as a cryptographic method analogous to an elliptical curve encryption, for short ECC, from a private key of a corresponding cryptography method. The reverse function, i.e. the creation of a token (or the part of the electronic coin data set) from a token reference, is very time-consuming here.

The (mere) knowledge or the possession of a token reference does not afford the right to use/transmit/output the token value (token reference element). This represents a substantial difference between the token reference and the token.

After the cryptographic function has been applied to the private part of the token-individual key pair, the public part of the token-individual key pair is obtained as the second token reference element.

The token reference is formed from the token value (first token reference element) and the public part. This formation is preferably the linking (concatenation) of these two token reference elements. Any other type of chaining of these two token reference elements is not excluded according to the invention and includes, for example, back-end attachment, introduction into a TLV data structure and/or logical chaining.

A token reference can preferably be created by a computing unit of a secure element. For this purpose, the secure element must have knowledge of the token with its token elements. The token reference can be created by an electronic wallet of a secure element that wishes to send the token. Alternatively, the token reference can be created by an electronic wallet of a secure element which has received the token.

The use of a token reference is not comparable to the use of addresses of subscriber units in a blockchain-based transaction system, since no addresses of the secure elements are used in the token reference register according to the embodiments of the current disclosure to prevent the possibility of the tokens being tracked.

A registration request provides a token reference to a token register. For example, the registration request is sent by a secure transaction unit of the electronic token transaction system or a token issuer of the electronic token transaction system.

The token register may store the token references, whereby the assignable tokens are registered. This register can be a central database or memory unit. This register can be a decentralized ledger, for example in a blockchain topology. The token register can maintain a history of the token references and/or the registration requests.

In the token register, a token reference is only stored once. Since a token reference of a token is present only once in the electronic token transaction system, it can be established by the token register whether an attempt has been made to output a token several times.

The received token reference may be stored in a memory unit of the token register. The memory may be used to register in the electronic token transaction system the token uniquely assigned to the received token reference. The storage process takes place only if it is determined that the at least one token reference of the received registration request is not stored in the token register.

The basic principle of registering a token is therefore that a received registration request is verified to determine whether the token reference assigned to the token is already known in the token register. If the token reference is already known, it will not be stored again. If the token reference is not known, it may be entered (stored) into the token register in order to be available in the transaction system for future verification and checking steps.

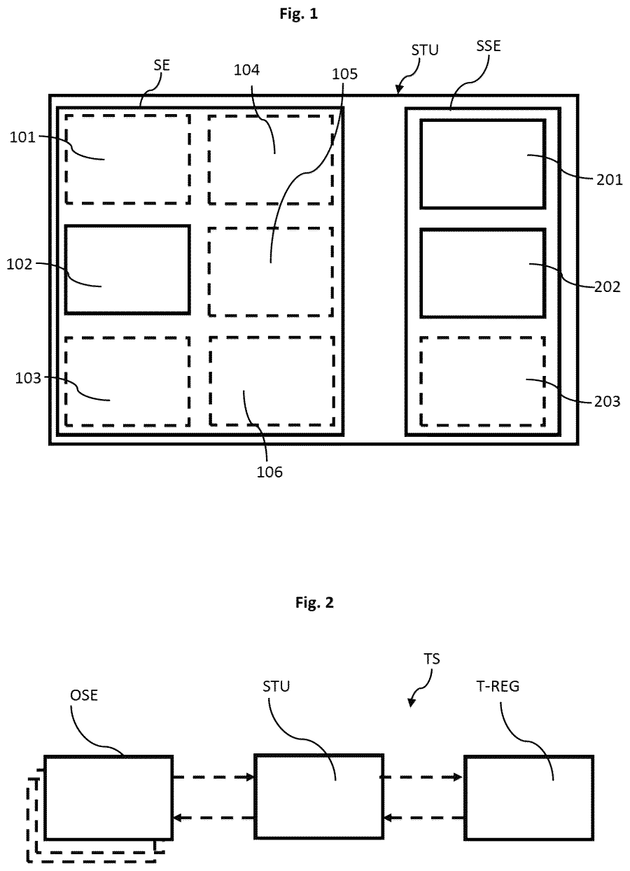

In FIG. 1, an exemplary embodiment of a secure transaction unit according to an embodiment of the current disclosure is depicted. The secure transaction unit STU for use in an electronic token transaction system TS comprises a secure element SE and a special secure element SSE. The special secure element SSE is configured for temporary, i.e. as long as a connection of the secure element and the token register is not sufficient to provide a registration of the token, offline storing of history data related to tokens being transacted within offline token transactions, an offline token transaction meaning token transfer without token registration but with the storing of history data for later registration.

Both, the secure element SE and the special secure element SSE are fully included respectively arranged within the secure transaction unit STU. The secure element SE comprises a means 102 configured for receiving at least one token from another secure element OSE when performing an offline token transaction between the secure element SE and the other secure element OSE. The special secure element SSE comprises a means 201 configured for receiving directly or indirectly the history data related to the received at least one token from the other secure element OSE for temporary offline storing of history data related to a token transaction performed by the secure element SE and a means 202 configured for providing the temporarily stored history data to a token register T-REG. By this secure transaction unit having a secure element SE and a special secure element SSE the data size of a token can be significantly reduced, e.g. when performing such further offline transactions, such that the computing power of the secure element can be relieved such that a time duration of a transmission, receipt and/or transmission of the token can be significantly decreased and the number of possible token transactions can be significantly increased.

In some embodiments, the special secure element SSE may temporarily store the history data in order to avoid that the secure element SE is blocked for further transactions. For example, the secure transaction unit STU may be configured such that the secure element SE performs a further offline transaction and, in parallel, the special secure element SSE registers the token of the secure element SE. This parallel processing further reduces the time duration of the token transfer and provides an advantageous increase in the number of token transactions the secure element SE can perform, without reducing security, flexibility, or anonymity of the electronic token in the electronic token transaction system.

Optionally, the secure element SE further comprises a means 101 configured for providing a token transaction request to another secure element OSE.

Optionally, the secure element SE further comprises a means 103 configured for receiving the history data from the other secure element OSE, a means 104 configured for providing the history data to the special secure element SSE, and/or a means 105 configured for providing a registration request to the special secure element SSE for providing the history data to the token register T-REG.

Optionally, the special secure element SSE further comprises a means 203 configured for receiving the registration request from the secure element SE.

Optionally, the secure element SE further comprises a means 106 configured for receiving a registration response from the token register T-REG.

In FIG. 2, an exemplary embodiment of an electronic token transaction system is depicted. The electronic token transaction system TS comprises a plurality of other secure elements OSE, at least one secure transaction unit STU as described above, and at least one token register T-REG. The plurality of other secure elements OSE, the at least one secure transaction unit STU, and the at least one token register T-REG are communicatively coupled to each other. The plurality of other secure elements OSE, the at least one secure transaction unit STU and the at least one token register T-REG are spaced apart from each other.

A secure element or special secure element according to various embodiments of the disclosure may comprise a computing unit or processor, as well as a data memory and may further comprise a communication interface for sending and receiving, such as a wireless or wired communication interface, or an optical communication interface, e.g., via QR code or barcode, which can be designed as a secure channel. The secure element and/or the special secure element may be, for example, installed in a terminal or other device ready for use. The secure element and/or the special secure element may be designed, for example, as special hardware, such as in the form of a secured hardware platform module, Trusted Platform Module (TPM), or as an embedded security module, eUICC, eSIM, and/or may have a secured runtime environment within an operating system of a terminal or device. The secure element and/or the special secure element provides a trusted environment.

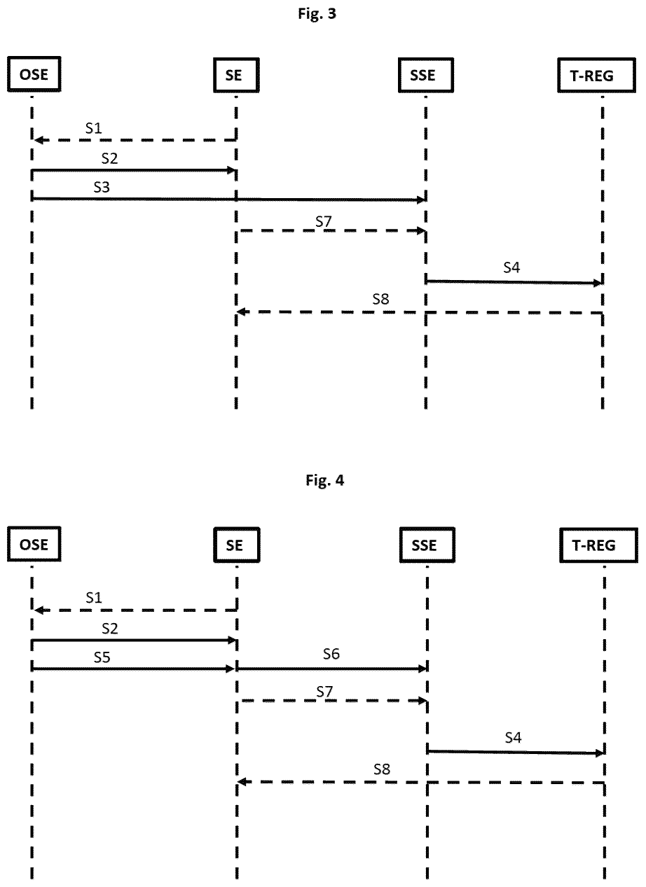

In FIG. 3, an exemplary embodiment of a method in a secure transaction unit of an electronic token transaction system in which the history data are directly provided from the other secure element to the special secure element. The method comprises the following steps: receiving S2 by a secure element SE at least one token from another secure element OSE when performing an offline token transaction between the secure element SE and the other secure element OSE, receiving S3 by a special secure element SSE history data directly or indirectly from the other secure element OSE for temporary offline storing of the history data related to token transaction performed by the secure element SE, providing S4 the history data for a registration from the special secure element SSE to a token register T-REG of the electronic token transaction system TS.

Optionally, the method further comprises at least one of the following steps: providing S7 a registration request from the secure element SE to the special secure element SSE, receiving S8 by the secure element SE a registration response from the token register T-REG, and providing S1 a token transaction request from a secure element SE to another secure element OSE.

In FIG. 4, an exemplary embodiment of a method in a secure transaction unit of an electronic token transaction system in which the history data are indirectly provided from the other secure element to the special secure element. The method comprises the following steps: receiving S2 by a secure element SE at least one token from another secure element OSE when performing an offline token transaction between the secure element SE and the other secure element OSE, receiving S5 by the secure element SE history data from the other secure element OSE, providing S6 the received history data from the secure element SE to the special secure element SSE, receiving by the special secure element SSE history data directly or indirectly from the secure element SE for temporary offline storing of the history data related to token transaction performed by the secure element SE, providing S4 the history data for a registration from the special secure element SSE to a token register T-REG of the electronic token transaction system TS.

Optionally, the method further comprises at least one of the following steps: providing S7 a registration request from the secure element SE to the special secure element SSE, receiving S8 by the secure element SE a registration response from the token register T-REG, and providing S1 a token transaction request from a secure element SE to another secure element OSE.

A token history or history data may include two or more token history entries, each corresponding to a token transaction such as a current transaction and/or one or more previous transactions. Each of the two or more token history entries may refer to an unregistered token of the offline token transaction of the secure element, of a previous transaction of the other secure element, or of a previous transaction of a further other secure element. For example, at least one first token history entry of the two or more token history entries may allow the token register to register a previous token and a second token history entry of the two or more token history entries may allow the token register to register a received token.

Each token history entry of the token history, when sent to the token register, leads to registration of at least one unregistered token as an output and needs at least one registered token as an input. As such, a token history may include a chain of such token history entries due to multiple previous offline transactions (e.g. one or more transaction of the other secure element and one or more previous transactions of further other secure elements).

Such a token history may comprise a sequence of entries or chained entries, for example corresponding to a sequence of registration requests or chained registration requests. Further aspects of an electronic token transaction system, including use of a sequence of registration requests or chained registration requests, may be included in the described embodiments, for example in a manner as described in U.S. patent application Ser. No. 18/681,041 and International Patent Application PCT/DE2023/100487, which applications are each incorporated herein by reference in their entirety as indicated previously.

According to various embodiments, the secure element may be configured to modify tokens (switch, split, merge). In a preferred embodiment the secure element is configured to create one or more (m) output tokens based on one or more (n) input tokens. m=n(=1) may be called a switch. n<m may be called a split. n>m may be called a merge. The monetary value of the input tokens equals the monetary value of the output tokens. Stored input tokens of the secure element may be modified/replaced by created output tokens. Within a transaction typically one or more (m) output tokens may be created and/or one or more (of the) output token(s) is exchanged.

History data may comprise one or more history data entries. One history data entry is provided in the history data per token replacement/modification. Hence, the history data may comprise one or more history data entries from previous transactions and/or a history data entry from a current transaction.

The history data enables registration of an output token in the token register. The history data and/or each history data entry preferably comprises replacement verification data, such as a signature. The verification data enables the token register to verify the correctness of the replacement and/or that the replacement used the one or more input tokens. In particular, history entries may comprise one token signature, created by a token individual token secret of an input token, preferably one signature per input token.

In a preferred embodiment the (special) secure element is configured to send a token (reference) replacement request to the token (reference) register. The token (reference) replacement requesting the token (reference) register to replace an existing registration of one or more (n) tokens, input tokens, by registration of one or more (m) tokens, output tokens.

1. A secure transaction unit for use in an electronic token transaction system, the secure transaction unit comprising:
a secure element; and
a special secure element for temporary offline storing of history data related to tokens being transacted within offline token transactions;
wherein the secure element comprises:
a secure element computing unit configured for receiving at least one token from another secure element when performing an offline token transaction between the secure element and the other secure element;
wherein the special secure element comprises:
a special secure element computing unit configured for directly or indirectly receiving history data, the received history data being related to the at least one token received by the secure element from the other secure element, for temporary offline storing of the received history data, and for registration of the at least one received token in a token register, by providing the temporarily stored history data to the token register.

2. The secure transaction unit according to claim 1, wherein the secure transaction unit is configured such that the secure element performs a further offline transaction and, in parallel, the special secure element registers the token of the secure element.

3. The secure transaction unit according to claim 1, wherein the received history data comprises two or more token history entries.

4. The secure transaction unit according to claim 3, wherein, each of the two or more token history entries refers to an unregistered token of the offline token transaction of the secure element, of a previous transaction of the other secure element, or of a previous transaction of a further other secure element.

5. The secure transaction unit according to claim 3, wherein at least one first token history entry of the two or more token history entries allows the token register to register a previous token and thereafter a second token history entry of the two or more token history entries allows the token register to register the received token.

6. The secure transaction unit according to claim 1, wherein the secure element comprises a data memory configured for storing the at least one received token.

7. The secure transaction unit according to claim 6, wherein the at least one received token is modified by the secure element computing unit.

8. The secure transaction unit according to claim 7, wherein the secure element comprises a data memory configured for storing the at least one received token.

9. The secure transaction unit according to claim 1, wherein the secure transaction unit is a merchant terminal.

10. The secure transaction unit according to claim 1, wherein the secure token transaction unit or the secure element computing unit is further configured for providing a token transaction request to the other secure element.

11. The secure transaction unit according to claim 1, wherein the secure element computing unit is further configured for:
receiving the history data from the other secure element;
providing the history data to the special secure element, and/or
providing a registration request to the special secure element for providing the history data to the token register.

12. The secure transaction unit according to claim 11, wherein the special secure element computing unit is further configured for receiving the registration request from the secure transaction unit or the secure element computing unit.

13. The secure transaction unit according to claim 1, wherein the secure element computing unit is further configured for receiving a registration response from the token register.

14. An electronic token transaction system comprising:
a plurality of other secure elements;
at least one secure transaction unit according to claim 1, and
at least one token register.

15. A method in a secure transaction unit of an electronic token transaction system, the method comprising the following steps:
receiving by a secure element computing unit at least one token from another secure element when performing an offline token transaction between the secure element computing unit and the other secure element;
receiving by a special secure element computing unit history data directly or indirectly from the other secure element for temporary offline storing of the history data related to the offline token transaction performed by the secure element computing unit;
providing the history data for a registration from the special secure element computing unit to a token register of the electronic token transaction system.

16. The method according to claim 15, when the received history data are indirectly provided to the special secure element computing unit, the method further comprising the step of:
receiving the history data by the secure element computing unit from the other secure element; and
providing the received history data from the secure element computing unit to the special secure element computing unit.

17. The method according to claim 15, further comprising the step of:
providing a registration request from the secure element computing unit to the special secure element computing unit; and/or
receiving by the secure element computing unit a registration response from the token register; and/or
providing a token transaction request from the secure element computing unit to another secure element.

18. The method according to claim 15, further comprising the step of the secure element computing unit performing a further offline transaction and, in parallel, the special secure element computing unit registering the at least one token received by the secure element computing unit from the other secure element.

19. The method according to claim 15, wherein the received history data comprises two or more token history entries.

20. The method according to claim 19, wherein, each of the two or more token history entries refers to an unregistered token of the offline token transaction of the secure element computing unit, of a previous transaction of the other secure element, or of a previous transaction of a further other secure element.
